(19) United States
(12) Patent Application Publication
(10) Pub. No.: US 2020/0224607 A1
(43) Pub. Date: Jul. 16, 2020

(54) AIRCRAFT AND ENGINE THEREOF

(71) Applicant: AECC Hunan Aviation Powerplant Research Institute, Zhuzhou (CN)

(72) Inventors: Zeyong Yin, Zhuzhou (CN); Shizhi Wu, Zhuzhou (CN); Jianbing Cai, Zhuzhou (CN); Quan Wen, Zhuzhou (CN); Zhaoguang Wang, Zhuzhou (CN); Jiancheng Shi, Zhuzhou (CN); Qinglin Guo, Zhuzhou (CN)

(73) Assignee: AECC Hunan Aviation Powerplant Research Institute, Zhuzhou (CN)

(21) Appl. No.: 16/818,374

(22) Filed: Mar. 13, 2020

Related U.S. Application Data
(63) Continuation of application No. PCT/CN2019/000085, filed on Apr. 30, 2019.

(30) Foreign Application Priority Data
Nov. 7, 2018 (CN) 201811318875.0

(51) Int. Cl. F02K 3/06; F02C 3/067

(52) U.S. Cl. CPC F02K 3/06; F02C 7/36; F02C 3/067

(57) ABSTRACT

An aircraft engine includes an outer casing, an inner casing, a first rotating shaft, a first fan, a second fan, a first combustor, and a second combustor. The outer casing has an outer intake end and an outer exhaust end. The inner casing includes a first section and a second section arranged in an axial direction. The first rotating shaft is rotatably disposed in the inner casing. The first fan includes an inner turbine portion, a first connection portion, and an outer turbine portion. The second fan is connected to the first rotating shaft and disposed on the outer intake end side of the first section wherein an outer diameter of the second fan is larger than that of the first section. The first combustor is disposed between the second fan and the outer turbine portion. The second combustor is disposed between the second fan and the inner turbine portion.

### CROSS REFERENCES TO RELATED APPLICATIONS

This application is a continuation of PCT Application No. PCT/CN2019/000085, filed on Apr. 30, 2019, which claims priority to Chinese Application No. CN201811318875.0, filed on Nov. 7, 2018. The entire contents of these applications are incorporated herein by reference.

### BACKGROUND

The present disclosure relates to the field of aviation technology, and in particular, to an aircraft and an engine thereof.

At present, with the development of aviation technology, requirements for better aircraft performance are becoming higher and higher. Among these requirements, the performance of the engine, which is a core component of the aircraft, is directly related to the performance of the aircraft. Among all types of engines, turbofan engines are relatively widely used. Existing turbofan engines generally include a core duct and a bypass duct. A core flow enters an exhaust nozzle after passing through a compressor and a combustor while a bypass flow directly enters the exhaust nozzle. Airflows from the core duct and the bypass duct are mixed in the exhaust nozzle and then ejected to provide thrust for the engine. Further, an afterburner is usually disposed between the bypass duct and exhaust nozzle to further burn the airflow from the core duct and the bypass duct, thus increasing the engine thrust. However, the afterburner also increases the length and fuel consumption of the engine.

Patent Document CN1975130A discloses a turbofan engine structure, which includes a fan, a core compressor, a core combustor, a high-pressure turbine, a low-pressure turbine, and an afterburner. Patent Document U.S. Pat. No. 7,500,352B2 discloses a turbofan engine structure, which includes a bypass duct, a core duct (the duct corresponding to the “core intake”), a fan unit, a compressor, a combustor, a turbine, an inner casing, and an outer casing. According to U.S. Pat. No. 7,500,352B2, a radial bypass structure can be realized in the engine structure. This Patent Document (U.S. Pat. No. 7,500,352B2) also discloses a typical structure of a second fan blade. The second fan blade located in the bypass duct can be an outward extension of a fan blade in the core duct or an outward extension of a turbine blade in the core duct, and airflows into the core duct and the bypass duct are separated by a flow splitter. Patent Document U.S. Pat. No. 2,548,975A discloses a gas turbine engine with two-tier blading formed by joining turbine blades and compressor rotor blades. A characteristic of the two-tier blading is that the turbine blades are outward extensions of the compressor blades. Based on U.S. Pat. No. 7,500,352B2 and U.S. Pat. No. 2,548,975A, it is concluded that a structure of internal/external two-tier blading is feasible.

### SUMMARY

One or more embodiments of the present invention provide an aircraft and an engine thereof which may advantageously increase engine thrust, and reduce engine length and fuel consumption.

According to one aspect of the present disclosure, an aircraft engine is provided, the aircraft engine including:

an outer casing having an outer intake end and an outer exhaust end;

an inner casing disposed in the outer casing, wherein a bypass duct is formed between the inner casing and the outer casing, wherein the inner casing defines a core duct, wherein the inner casing includes a first section and a second section arranged in an axial direction with an interval, and wherein the first section is disposed on an outer intake end side of the second section;

a first rotating shaft rotatably disposed in the inner casing;

a first fan including an inner turbine portion, a first connection portion, and an outer turbine portion, wherein the inner turbine portion is connected to the first rotating shaft and disposed in the core duct, wherein the first connection portion is circumferentially connected to an outer periphery of the inner turbine portion and rotatably fitted between the first section and the second section, and wherein the outer turbine portion is circumferentially connected to an outer periphery of the first connection portion and is disposed in the bypass duct;

a second fan connected to the first rotating shaft and disposed on the outer intake end side of the first section, wherein an outer diameter of the second fan is larger than an outer diameter of the first section;

a first combustor disposed in the bypass duct and between the second fan and the outer turbine portion; and

a second combustor disposed in the core duct and between the second fan and the inner turbine portion.

In one or more embodiments of the present invention, the second fan includes:

an inner blade portion connected to the first rotating shaft and opposite to the core duct;

a second connection portion circumferentially connected to an outer periphery of the inner blade portion and rotatably fitted to the first section; and

an outer blade portion circumferentially connected to an outer periphery of the second connection portion and opposite to the bypass duct.

In one or more embodiments of the present invention, the outer blade portion includes a plurality of outer blade groups distributed in the axial direction. Each outer blade group includes a plurality of outer blades distributed circumferentially.

In one or more embodiments of the present invention, a surface of the first connection portion facing the first section is provided with a first annular groove, into which the first section is rotatably fitted. A surface of the first connection portion facing the second section is provided with a second annular groove, into which the second section is rotatably fitted.

In one or more embodiments of the present invention, the aircraft engine further includes:

a second rotating shaft rotatably disposed in the first section and provided with a through cavity in the axial direction, wherein the first rotating shaft coaxially runs through the cavity and rotates independent of the second rotating shaft; and

a compressor assembly connected to the second rotating shaft and disposed in the core duct and between the second fan and the second combustor.

In one or more embodiments of the present invention, the compressor assembly includes a plurality of compressor blade groups distributed in the axial direction. Each compressor blade group includes a plurality of compressor blades distributed circumferentially.

In one or more embodiments of the present invention, the aircraft engine further includes:

a turbine assembly connected to the second rotating shaft and disposed in the core duct and between the inner turbine portion and the second combustor.

In one or more embodiments of the present invention, the aircraft engine further includes:

a first support that is fixed in the first section and extends in a radial direction of the first section;

a second support that is fixed in the second section and extends in a radial direction of the second section; and

a third support that is fixed in the second section and extends in a radial direction of the second section.

One end of the first rotating shaft is rotatably connected to the first support, and the other end of the first rotating shaft is rotatably connected to the second support.

The second rotating shaft is rotatably connected to the third support.

According to another aspect of the present disclosure, provided is an aircraft that includes an aircraft engine according to one or more embodiments described above.

During operation of the aircraft and the engine thereof according to one or more embodiments of the present invention, both the first fan and the second fan rotate. An airflow enters the bypass duct and the core duct due to the rotation of the second fan. The airflow that enters the core duct is burnt in the first combustor and then exhausted after being expanded by the outer turbine portion of the first fan so as to increase the thrust generated by the airflow of the bypass duct, thereby increasing the engine thrust. Further, the airflow that enters the bypass duct is burnt in the second combustor and then exhausted after being expanded by the inner turbine portion of the first fan so as to generate thrust by the airflow of the core duct. Further, since the pressure of the airflow in the core duct is increased by the first fan and second fan, and since the temperature of the airflow in the core duct is increased due to heat transfer from the first combustor to the core duct, the thrust generated by the airflow of the core duct is increased, thereby increasing the engine thrust. In addition, due to the increase of the engine thrust, an afterburner is not required or may be shortened, which helps reduce the length of the engine.

It should be understood that both the general description above and the detailed description below are only exemplary and explanatory and are not intended to limit the scope of the present invention.

### BRIEF DESCRIPTION OF DRAWINGS

FIG. 1 is a schematic diagram of an engine of related art.

FIG. 2 is a schematic diagram of an engine according to one or more embodiments of the present invention.

FIG. 3 is a schematic diagram of a first fan of an engine according to one or more embodiments of the present invention.

FIG. 4 is a schematic diagram of a second fan of an engine according to one or more embodiments of the present invention.

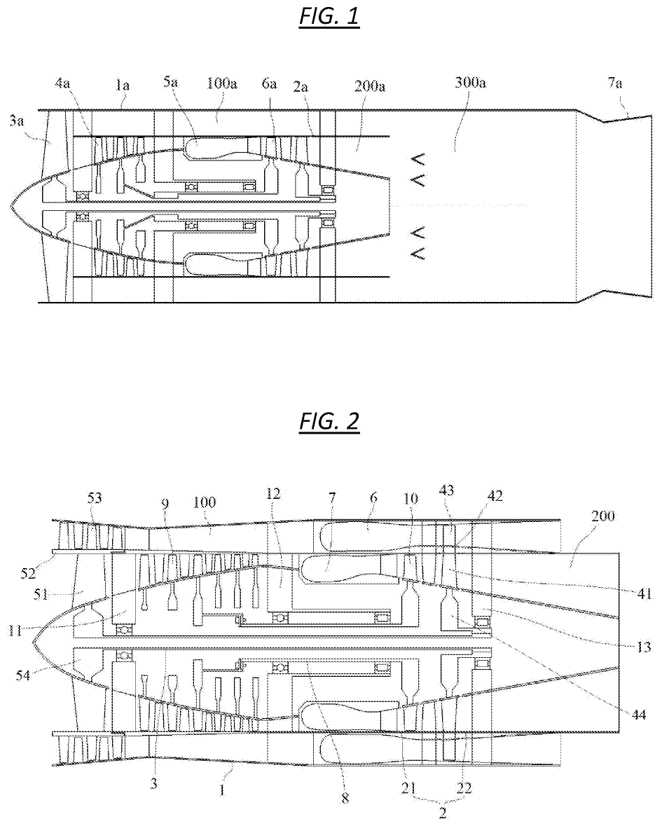

In FIG. 1: la, outer casing; 2a, inner casing; 3a, fan; 4a, compressor; 5a, combustor; 6a, turbine; 7a, nozzle; 100a, bypass duct; 200a, core duct; 300a, afterburner

In FIGS. 2-4: 1, outer casing; 2, inner casing; 21, first section; 22, second section; 3, first rotating shaft; 4, first fan; 41, inner turbine portion; 42, first connection portion; 43, outer turbine portion; 44, inner turbine center portion; 5, second fan; 51, inner blade portion; 52, second connection portion; 53, outer blade portion; 54, inner blade center portion; 6, first combustor; 7, second combustor; 8, second rotating shaft; 9, compressor assembly; 10, turbine assembly; 11, first support; 12, second support; 13, third support; 100, bypass duct; 200, core duct.

### DETAILED DESCRIPTION

Embodiments of the present invention will be described in detail with reference to the figures. However, other embodiments can be devised, the invention should not be understood as being limited to the embodiments described herein. Like signs in the figures designate like elements, and thus detailed descriptions of like signs will be omitted.

Although relative terms, such as “upper” and “lower”, which indicate the relative relationship between one component and another in the figures, are commonly used in the Description, they are merely used for the sake of convenience, for instance, for indicating directions in the examples shown in figures. It will be appreciated that if an apparatus in a figure is turned upside down, an “upper” component will become a “lower” one. When a structure is described as disposed “on” another structure, it may mean that the former is integrally formed on the latter, or that the former is “directly” disposed on the latter, or that the former is “indirectly” disposed on the latter by way of another structure. The terms “first,” “second,” and “third” are merely used for differentiation between elements and are not used as limitations on the number of elements.

In related art, as shown in FIG. 1, an engine may include an outer casing 1a and an inner casing 2a. The inner casing 2a is disposed coaxially inside the outer casing 1a. A bypass duct 100a is formed between the outer casing 1a and the inner casing 2a, and a core duct 200a is formed inside the inner casing 2a. A fan 3a is provided inside the outer casing 1a and outside the inner casing 2a. A compressor 4a, a combustor 5a, and a turbine 6a are provided in the core duct 200a along a direction of airflow. During operation, an airflow may be generated by the fan 3a, which will enter the bypass duct 100a and core duct 200a. For the core duct 200a, by the collaboration of the compressor 4a, the combustor 5a, and the turbine 6a, an airflow with high pressure will be ejected from the core duct 200a. An airflow from the bypass duct 100a will be mixed with the airflow form the core duct 200a in a nozzle 7a and ejected so as to produce thrust. If additional thrust is desired for the engine, an afterburner 300a may be provided between the bypass duct 1a and the nozzle 7a to further burn the airflow from the core duct 200a and the bypass duct 100a, so as to increase the engine thrust.

However, in the related art, when the afterburner 300a is provided in the engine, a total length of the engine will be increased, in which a length of the combustor 300a takes up more than 30% of the length of the engine. Meanwhile, although the engine thrust is increased by 60%, fuel consumption is increased by 150%˜200%.

One or more embodiments of the present invention provide an engine for an aircraft. An engine according to one or more embodiments, as illustrated in FIGS. 2 to 4, may include an outer casing 1, an inner casing 2, a first rotating shaft 3, a first fan 4, a second fan 5, a first combustor 6, and a second combustor 7.

The outer casing 1 has an outer intake end and an outer exhaust end.

The inner casing 2 is disposed inside the outer casing 1. A bypass duct 100 is formed between the inner casing 2 and outer casing 1, and a core duct 200 is formed inside the inner casing 2. The inner casing 2 includes a first section 21 and a second section 22 arranged in an axial direction with an interval. The first section 21 is disposed on an outer intake end side of the second section 22.

The first rotating shaft 3 may be rotatably disposed inside the inner casing 2.

The first fan 4 may include an inner turbine portion 41, a first connection portion 42, and an outer turbine portion 43. The inner turbine portion 41 is connected to the first rotating shaft 3 and disposed in the core duct 200. The first connection portion 42 is circumferentially connected to an outer periphery of the inner turbine portion 41 and is rotatably fitted between the first section 21 and second section 22. The outer turbine portion 43 is circumferentially connected to an outer periphery of the first connection portion 42 and is located in the bypass duct 100.

The second fan 5 may be connected to the first rotating shaft 3 and may be disposed near on the outer intake end side of the first section 21. An outer diameter of the second fan 5 is larger than an outer diameter of the inner casing 2.

The first combustor 6 may be disposed in the bypass duct 100 and between the first fan 4 and the second fan 5.

The second combustor 7 may be disposed in the core duct 200 and between the second fan 5 and the inner turbine portion 41.

During operation of the engine according to one or more embodiments of the present invention, when the first fan 4 and the second fan 5 rotate, an airflow is caused to enter the bypass duct 100 and the core duct 200. The airflow that enters the bypass duct 100 acts on the outer turbine portion 43 of the first fan 4 after being burnt in the first combustor 6, and then is exhausted after expansion so as to increase the thrust produced by the airflow in the bypass duct 100, thereby increasing the engine thrust. Meanwhile, the airflow that enters the core duct 200 is burnt in the second combustor 7 and then exhausted after being expanded by the inner turbine portion 41 of the first fan 4, thus producing a thrust. Furthermore, since the pressure of the airflow in the core duct 200 is increased by the first fan 4 and second fan 5, and since the temperature of the airflow in the core duct 200 is increased due to heat transfer from the first combustor 6 to the core duct 200, the thrust generated by the airflow of the core duct 200 is increased, thereby increasing the engine thrust. In addition, due to the increase of the engine thrust, an afterburner is not required or may be shortened, which helps reduce the length of the engine. By experimental verification, in one or more embodiments, fuel consumption of the engine may be decreased by 150%, the engine length may be shortened by ⅓, and the thrust-weight ratio may be increased by 60%, as compared with existing engines.

Detailed description of the components of an engine according to one or more embodiments will be given next with reference to the figures.

As shown in FIG. 2, the outer casing 1 may be a tubular structure. A cross section of the outer casing 1 may have a circular shape, an elliptical shape, a polygonal shape, or the like, which is not specifically limited herein. Further, the outer casing 1 may be provided with a run-through outer air intake and outer air outlet for airflow passing through.

As shown in FIG. 2, the inner casing 2 may be a tubular structure. A cross section of the inner casing 2 may be a circular shape, an elliptical shape, a polygonal shape, or the like, which is not specifically limited herein. The inner casing 2 is disposed inside the outer casing 1 coaxially. That is to say, central axes of the outer casing 1 and the inner casing 2 are collinear, such that the bypass duct 100 for airflow to pass through is formed between the inner casing 2 and outer casing 1. Further, the inner casing 2 is provided with the core duct 200 for airflow to pass through. The method for forming the core duct 200 is not specifically limited herein. One end of the core duct 200 is an inner intake end facing the outer intake end of the outer casing 1. The other end of the core duct 200 is an inner exhaust end, which may be located inside or extend beyond the outer exhaust end of the outer casing 1. In the case where the core duct 200 extends beyond the outer exhaust end or aligns with the outer exhaust end, mixing of, and thereby interference between, exhaust gas flows respectively ejected from the bypass duct 100 and the core duct 200 may be prevented.

The inner casing 2 may include a first section 21 and a second section 22. The first section 21 and the second section 22 may each be a tubular structure and may be spaced apart by an interval along the axial direction. That is to say, central axes of the first section 21 and the second section 22 are collinear, and a pre-determined interval exists along the axial direction. Further, the first section 21 is located on the outer intake end side of the second section 22, the inner intake end of the inner casing 2 is an end of the first section 21 close to the outer intake end, and the inner exhaust end of the inner casing 2 is a distal end of the second section 22 from the first section 21.

As shown in FIG. 2, the first rotating shaft 3 is disposed rotatably in the inner casing 2. A central axis of the first rotating shaft 3 and the central axis of the inner casing 2 are collinear, and the core duct 200 surrounds the first rotating shaft 3.

As shown in FIG. 2, in order to facilitate supporting of the first rotating shaft 3, a first support 11 and a third support 13 may be provided in the inner casing 2. The first support 11 and the third support 13 may be distributed in the axial direction. The first support 11 may be fixed to the first section 21 and extend in a radial direction of the first section 21. The third support 13 may be fixed to the second section 22 extend in a radial direction of the second section 22. One end of the first rotating shaft 3 may pass through the first support 11, and the first rotating 3 may be rotatably connected to the first support 11 via one or more bearings. The other end of the first rotating shaft 3 may be rotatably connected to the third support 13 via one or more bearings. Thus, the first rotating shaft 3 is rotatably disposed inside the first section 21 of the inner casing 2. Alternatively, the first rotating shaft 3 may be rotatably disposed inside the first section 21 through other mounting means, of which no detailed description will be provided herein.

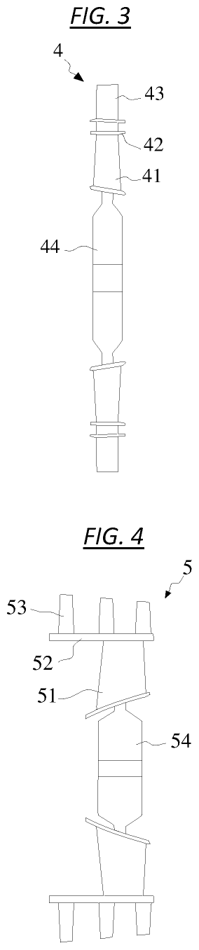

As shown in FIG. 2 and FIG. 3, the first fan 4 may be connected to the first rotating shaft 3, extend into the bypass duct 100 through the interval between the first section 21 and the second section 22, and rotate with respect to the first section 21 and the second section 22.

In one or more embodiments, as shown in FIG. 2 and FIG. 3, the first fan 4 may include the inner turbine portion 41, the first connection portion 43, and the outer turbine portion 43.

The inner turbine portion 41 may be connected to the first rotating shaft 3 and be disposed in the core duct 200. An outer periphery of the inner turbine portion 41 may be rotatably fitted to an inner wall of the inner casing 2. The inner turbine portion 41 may rotate synchronously with the first rotating shaft 3 and serve as a turbine for the core duct 200. For example, the inner turbine portion 41 may be connected to the first rotating shaft 3 via an inner turbine center portion 44. Specifically, the first fan 4 may further include the inner turbine center portion 44, which may be fitted and fixed to the first rotating shaft 3. The inner turbine portion 41 is circumferentially connected to the inner turbine center portion 44 and fixed thereto by, for example, interlocking, welding, and integral molding. A stop portion that extends in the axial direction may be formed on a periphery of the inner turbine center portion 44. A space between the stop portion and the inner casing 2 may be a part of the core duct 200 such that the inner turbine portion 41 is within the core duct 200.

The inner turbine portion 41 may include multiple inner turbine blade groups distributed along the axial direction. Each of the inner turbine blade groups may include multiple turbine blades distributed along a circumferential direction. The shape and dimension of the inner turbine blades are not specifically limited herein, as long as the inner turbine portion 41 can rotate under the effect of airflow. In some embodiments, the number (stage) of the inner turbine blade groups may be one.

The first connection portion 42 may be arranged around the inner turbine portion 41 and be circumferentially connected thereto in order to synchronously rotate with the inner turbine portion 41. Further, the first connection portion 42 is rotatably fitted between the first section 21 and the second section 22, separating the bypass duct 100 from the core duct 200 and causing the first fan 4 to pass through the inner casing 2. Further, the first connection portion 42 may rotate with respect to the inner casing 2. A passage formed between the first connection portion 42 and the inner casing 2 may be regarded as a part of the core duct 200. For example, the first connection portion 42 may be of an annular structure. The inner turbine portion 41 may be located inside the first connection portion 42 and connected to an inner wall of the first connection portion 42 by welding, interlocking, integral molding, or the like.

The outer turbine portion 43 may be arranged around the first connection portion 42 and be circumferentially connected thereto by welding, interlocking, integral molding, or the like such that the outer turbine portion 43 synchronously rotates with the inner turbine portion 41 and the first connection portion 42. Further, the outer turbine portion 43 may be located within the bypass duct 100, and an outer periphery thereof is rotatably fitted to an inner wall of the outer casing 1. The outer turbine portion 43 is a portion of the first fan 4 that extends into the bypass duct 100.

The outer turbine portion 43 may include multiple outer turbine blade groups distributed along the axial direction. Each of the outer turbine blade groups may include multiple turbine blades distributed along a circumferential direction. The shape and dimension of the outer turbine blades are not specifically limited herein, as long as the outer turbine portion 43 can rotate under the effect of airflow. In some embodiments, the number (stage) of the outer turbine blade groups may be one.

The inner turbine portion 41, the first connection portion 42, and the outer turbine portion 43 may form an integral structure or be separate structures fixedly connected. The inner turbine center portion 44 and the inner turbine portion 41 may form an integral structure or be separate structures fixedly connected.

As shown in FIG. 2 and FIG. 4, the second fan 5 may be disposed in the outer casing 1 and on the outer intake end side of the inner casing 2. The second fan 5 may be connected to the first rotating shaft 3 in order to rotate synchronously with the first rotating shaft 3. An outer diameter of the second fan 5 may be greater than an outer diameter of the inner casing 2 such that an outer periphery of the second fan 5 extends to a corresponding position in the bypass duct 100. During rotation of the second fan 5, an airflow may enter both the bypass duct 100 and the core duct 200.

In one or more embodiments, as shown in FIG. 2 and FIG. 4, the second fan 5 may include an inner blade portion 51, a second connection portion 52, and an outer blade portion 53.

The inner blade portion 51 may be connected to the first rotating shaft 3 and may be opposite to the end of the first section 21 close to the outer intake end, that is, opposite to the core duct 200 in order that the airflow may enter the core duct 200. For example, the second fan 5 may further include an inner blade center portion 54. The inner blade portion 51 is connect to the first rotating shaft 3 through the inner blade center portion 54. Specifically, the inner blade center portion 54 may be fitted on the first rotating shaft 3 and fixed thereto. The inner blade portion 51 may be circumferentially connected to the inner blade center portion 54 by interlocking, welding, integral molding, or the like. An outer periphery of the inner blade portion 51 may be aligned with an inner periphery of the first section 21 or on the inside relative to the inner periphery of the first section 21.

The inner blade portion 51 may include at least one inner blade group. Each inner blade group may include multiple inner blades distributed along a circumferential direction. The shape and dimension of the inner blades are not specifically limited herein, as long as airflow can enter the core duct 200 during operation. In some embodiments, there may be multiple inner blade groups distributed along the axial direction.

The second connection portion 52 may be disposed around and circumferentially connected to the inner blade portion 51. Further, the second connection portion 52 may be aligned with the first section 21 such that a passage connected to the bypass duct 100 is formed between the second connection portion 52 and the outer casing 1. Indeed, this passage may also be regarded as a part of the bypass duct 100. The second connection portion 52 is rotatably fitted to the end of the first section 21 portion close to the outer intake end in order to ensure that the first section 21 does not cause interference to the rotation of the second fan 5. For example, the second connection portion 52 may be of an annular structure, and the inner blade portion 51 may located within the second connection portion 52 and connected to an inner wall of the second connection portion 52 by welding, interlocking, integral molding, or the like.

The outer blade portion 53 may be disposed around and circumferentially connected to the second connection portion 52 in order to synchronously rotate with the inner blade portion 51 and the second connection portion 52. The outer blade portion 53 is opposite to the bypass duct 100, and during the rotation of the outer blade portion 53, airflow can enter the bypass duct 100.

The outer blade portion 53 may include multiple outer blade groups, e.g., two or three groups, distributed along the axial direction. Each of said outer blade groups may include multiple outer blades circumferentially distributed. The shape and dimension of the outer blades are not specially limited herein, as long as during rotation of said blades, airflow can enter the bypass duct 100. In some embodiments, the number of outer blade groups may also be one.

The inner blade portion 51, the second connection portion 52, and the outer blade portion 53 may be an integral structure or separate structures fixedly connected. The inner blade center portion 54 and the inner blade portion 51 may be an integral structure or separate structures fixedly connected.

In other embodiments of the present invention, the second fan 5 may have any other structure, which will not be enumerated here, as long as airflow can enter the bypass duct 100 and the core duct 200 simultaneously.

As shown in FIG. 2, the first combustor 6 may be disposed within the bypass duct 100 and between the outer turbine portion 43 of the first fan 4 and second fan 5. The first combustor 6 may have an inlet facing the outer intake end of the outer casing 1 and an outlet facing the outer exhaust end of the outer casing 1. Airflow may enter the first combustor 6 through the inlet and exhaust gas may be discharged through the outlet. The airflow is burnt in the first combustor 6 to form a high temperature airflow, which is expanded by the outer turbine portion 43 and ejected in order to increase the thrust generated by the airflow of the bypass duct 100.

The first combustor 6 may form an integrated structure with the outer casing 1 or be an independent cavity in the outer casing 1.

The second combustor 7 may be disposed within the core duct 200 and between inner turbine portion 41 of the first fan 4 and second fan 5. The second combustor may have an inlet facing the outer intake end of the outer casing 1 and an outlet facing the outer exhaust end of the outer casing 1. Airflow compressed by a compressor assembly 9 may enter the second combustor 7 through the inlet, and exhaust gas is discharged through the outlet. The airflow is burnt in the second combustor 7 to form a high temperature airflow, which is expanded by inner turbine portion 41 and ejected in order to provide a thrust by the airflow through the core duct 200.

The second combustor 7 may form an integrated structure with the inner casing 2 or be an independent cavity in the inner casing 2.

As shown in FIG. 2, the engine according to one or more embodiments of the present invention may further include a second rotating shaft 8, the compressor assembly 9, and a turbine assembly 10.

The second rotating shaft 8 having a hollow cavity passing through its two ends may be rotatably disposed in the second section 22. The second rotating shaft 8 may be coaxially fitted on the outside of the first rotating shaft 3. In other words, the first rotating shaft 3 runs through the second rotating shaft 8 via the hollow cavity. Further, the first rotating shaft 3 may rotate with respect to the second rotating shaft 8 such that the second rotating shaft 8 and the first rotating shaft 3 may rotate independently.

In order to support the second rotating shaft 8, a second support 12 may be provided in the inner casing 2. The second support 12 may be fixed to the inner wall of the inner casing 2 and extend in a radial direction of the inner casing 2. The second support 12 may be located between the first support 11 and the third support 13. The second rotating shaft 8 is rotatably connected to the second support 12 such that the second rotating shaft 8 is rotatably disposed in the inner casing 2. The second support 12 may be located in the first section 21 or the second section 22 of the inner casing 2. Indeed, the second rotating shaft 8 may be rotatably disposed in the inner casing 2 through other installation methods, which will not be described in detail here, as long as there is no interference between the second rotating shaft 8 and the first rotating shaft 3.

In one or more embodiments, the second rotating shaft 8 may be connected to the first rotating shaft 3 by welding or integrally formed with the first rotating shaft 3 so as to realize synchronous rotation.

As shown in FIG. 2, the compressor assembly 9 may be connected to the second rotating shaft 8 and be located in the core duct 200 and between the second fan 5 and the second combustor 7. An outer periphery of the compressor assembly 9 is rotatably fitted to the inner wall of the inner casing 2 and may synchronously rotate with the second rotating shaft 8. The compressor assembly 9 may increase the airflow pressure in the core duct 200. For example, the compressor assembly 9 may be connected to the second rotating shaft 8 through a compressor center portion. Specifically, the compressor center portion may be fitted on and fixed to the second rotating shaft 8. The compressor assembly 9 is circumferentially connected to the compressor center portion by interlocking, welding, integral molding, or the like. A stopper portion that extends in the axial direction may be formed along an edge of the compressor center portion. A space between the stopper portion and the inner casing 2 is a part of the core duct 200 such that the compressor assembly 9 is within the core duct 200.

The compressor assembly 9 may include multiple compressor blade groups distributed along the axial direction. Each compressor blade group may include multiple compressor blades distributed along a circumferential direction. The shape and dimension of the compressor blades are not specifically limited herein, as long as pressurization of the airflow in the core duct 200 can be realized during rotation of the blades. In some embodiments, the number of the compressor blade groups may also be one.

As shown in FIG. 2, the turbine assembly 10 may be connected to the second rotating shaft 8 and be located in the core duct 200 and between the second combustor 7 and inner turbine portion 41. An outer periphery of the turbine assembly 10 may be rotatably fitted to the inner wall of the inner casing 2, and the turbine assembly 10 may synchronously rotate with the second rotating shaft 8. Exhaust gas from the second combustor 7 is expanded by the turbine assembly 10 and then expanded by the inner turbine portion 41 before being ejected, thereby providing a thrust by the airflow in the core duct 200. For example, the turbine assembly 10 may be connected to the second rotating shaft 8 via a turbine center portion. Specifically, the turbine center portion is circumferentially connected to the second rotating shaft 8 by interlocking, welding, integral molding, or the like. A stopper portion that extends in the axial direction may be formed along an edge of the turbine center portion. A space between the stopper portion and the inner casing 2 is a part of the core duct 200 such that the turbine assembly 10 is within the core duct 200.

The turbine assembly 10 may include multiple turbine blade groups distributed along the axial direction. Each turbine blade group may include multiple turbine blades distributed along a circumferential direction. The shape and dimension of the turbine blades are not specifically limited herein, as long as the turbine assembly 10 can rotate under the effect of the airflow to drive the rotation of the second rotating shaft 8. In some embodiments, the number (stage) of turbine blade groups of the turbine assembly 10 may also be one.

The engine according to one or more embodiments of the present invention may further include a nozzle. The nozzle may be a tail exhaust nozzle. One end of the nozzle is connected to the inner exhaust end of the inner casing 2, and the other end of the nozzle for discharging the exhaust gas extends toward the direction away from the inner casing 2. Additionally, the engine according to one or more embodiments of the present invention may further include other components, which will not be described in detail herein.

An aircraft including the above-described engine according to one or more embodiments of the present invention is also provided. The aircraft may be a fixed-wing aircraft, e.g., a UAV, or an aircraft of any other suitable types.

While the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An aircraft engine, comprising:
an outer casing having an outer intake end and an outer exhaust end;
an inner casing disposed in the outer casing,
wherein a bypass duct is formed between the inner casing and the outer casing,
wherein the inner casing defines a core duct,
wherein the inner casing comprises a first section and a second section arranged in an axial direction with an interval, and
wherein the first section is disposed on an outer intake end side of the second section;
a first rotating shaft rotatably disposed in the inner casing;
a first fan comprising an inner turbine portion, a first connection portion, and an outer turbine portion,
wherein the inner turbine portion is connected to the first rotating shaft and disposed in the core duct,
wherein the first connection portion is circumferentially connected to an outer periphery of the inner turbine portion and rotatably fitted between the first section and the second section, and
wherein the outer turbine portion is circumferentially connected to an outer periphery of the first connection portion and disposed in the bypass duct;
a second fan connected to the first rotating shaft and disposed on the outer intake end side of the first section,
wherein an outer diameter of the second fan is larger than an outer diameter of the first section;
a first combustor disposed in the bypass duct and between the second fan and the outer turbine portion; and
a second combustor disposed in the core duct and between the second fan and the inner turbine portion.

2. The aircraft engine according to claim 1, wherein the second fan comprises:
an inner blade portion connected to the first rotating shaft and opposite to the core duct;
a second connection portion circumferentially connected to an outer periphery of the inner blade portion and rotatably fitted to the first section; and
an outer blade portion circumferentially connected to an outer periphery of the second connection portion and opposite to the bypass duct.

3. The aircraft engine according to claim 2,
wherein the outer blade portion comprises a plurality of outer blade groups distributed in the axial direction, and
wherein each of the outer blade groups comprises a plurality of outer blades distributed circumferentially.

4. The aircraft engine according to claim 1,
wherein a surface of the first connection portion facing the first section is provided with a first annular groove,
wherein the first section is rotatably fitted into the first annular groove,
wherein a surface of the first connection portion facing the second section is provided with a second annular groove, and
wherein the second section is rotatably fitted into the second annular groove.

5. The aircraft engine according to claim 1, wherein the aircraft engine further comprises:
a second rotating shaft rotatably disposed in the first section and provided with a through cavity in the axial direction, wherein the first rotating shaft coaxially runs through the cavity and rotates independent of the second rotating shaft; and
a compressor assembly connected to the second rotating shaft and disposed in the core duct and between the second fan and the second combustor.

6. The aircraft engine according to claim 5,
wherein the compressor assembly comprises a plurality of compressor blade groups distributed in the axial direction, and
wherein each of the compressor blade groups comprises a plurality of compressor blades distributed circumferentially.

7. The aircraft engine according to claim 5, wherein the aircraft engine further comprises:
a turbine assembly connected to the second rotating shaft and disposed in the core duct and between the inner turbine portion and the second combustor.

8. The aircraft engine according to claim 5, wherein the aircraft engine further comprises:
a first support that is fixed in the first section and extends in a radial direction of the first section; and
a second support that is fixed in the second section and extends in a radial direction of the second section,
wherein one end of the first rotating shaft is rotatably connected to the first support, and
wherein the other end of the first rotating shaft is rotatably connected to the second support.

9. The aircraft engine according to claim 5, wherein the aircraft engine further comprises:
a third support that is fixed to the inner casing and extends in a radial direction of the inner casing,
wherein the second rotating shaft runs through the third support and is rotatably connected to the third support.

10. An aircraft, comprising the aircraft engine according to claim 1.
